(19) United States
(12) Patent Application Publication
(10) Pub. No.: US 2009/0100509 A1
(43) Pub. Date: Apr. 16, 2009

(54) EMERGENCY NOTIFICATION SYSTEM

(76) Inventor: Wendy Wolfsberger, St. Louis, MO (US)

Correspondence Address: POLSTER, LIEDER, WOODRUFF & LUCCHESI, 12412 POWERSCOURT DRIVE SUITE 200, ST. LOUIS, MO, 63131-3615, US

(21) Appl. No.: 12/191,856

(22) Filed: Aug. 14, 2008

Related U.S. Application Data
(60) Provisional application No. 60/955,758, filed on Aug. 14, 2007.

(51) Int. Cl. G06F 15/173; H04L 9/32; G06F 21/00

(52) U.S. Cl. 726/7; 709/224

(57) ABSTRACT

The emergency notification system includes a plurality of client devices operatively connected to a server through a communication network for communication of threats. The server administers a monitoring program that permits an administrator to monitor the user client device and communicate with users of the user client device regarding threats. Specifically, alert information and instructions is communicated to a discrete subset of client devices regarding a threat.

### CROSS-REFERENCE TO RELATED APPLICATIONS

This application is related to U.S. Provisional Patent Application No. 60/955,758 filed Aug. 14, 2007 from which priority is claimed, and is hereby incorporated by reference.

### STATEMENT REGARDING FEDERALLY SPONSORED RESEARCH

Not Applicable.

### BACKGROUND OF THE INVENTION

With increasing frequency, large “communities” of individuals are collectively affected by major, often life-threatening events that are beyond their control. From terror attacks to criminal assaults, severe weather to environmental accidents, these large, diverse, and dispersed “communities” require immediate information warnings and information to be better prepared to protect themselves and those around them.

The need has never been more evident than during the recent tragic events that recently befell the Virginia Tech campus. Early one morning in the Spring of 2007, a student was shot and killed in what appeared to be an isolated domestic confrontation. Within hours, dozens of unwitting students and professors lay dead. As the events of the day were later analyzed by school administrators, police officials, government agencies and countless pundits, one question began haunting the local, regional and national “community”. Why were the students at Virginia Tech not notified immediately that a potential lethal situation could be awaiting them on campus?

Disturbingly, no system was ever implemented or even available to notify the large groups of individuals (i.e. classroom) within a discrete subset of the larger population (i.e. campus) about the looming threat to their health and safety. Previously, communities have deployed public address systems, emergency weather sirens, and the Emergency Broadcast System as a method of notifying a large group about an impending threat. However, such systems cannot notify discrete subset of individuals within a larger population. Further, previous systems cannot indicate the nature of the various threats (i.e. tornado, terrorist attack, severe weather, fire, chemical).

Therefore, an emergency notification system that can quickly notify a discrete subset of people within a larger population of multiple types of threats is needed to address the growing problem of public threats to large communities of people and save lives.

### DESCRIPTION OF THE DRAWINGS

In the accompanying drawings which form part of the specification:

FIG. 1 is a block diagram of a emergency notification system;

FIG. 2 is a perspective view of a user client device in a safe mode;

FIG. 3 is a perspective view of the user client device in an alert mode; and

FIG. 4 is a front view of a display with a software page.

### DETAILED DESCRIPTION

The following detailed description illustrates the invention by way of example and not by way of limitation. The description clearly enables one skilled in the art to make and use the invention, describes several embodiments, adaptations, variations, alternatives, and uses of the invention, including what is presently believed to be the best mode of carrying out the invention. Additionally, it is to be understood that the invention is not limited in its application to the details of construction and the arrangements of components set forth in the following description or illustrated in the drawings. The invention is capable of other embodiments and of being practiced or carried out in various ways. Also, it is to be understood that the phraseology and terminology used herein is for the purpose of description and should not be regarded as limiting.

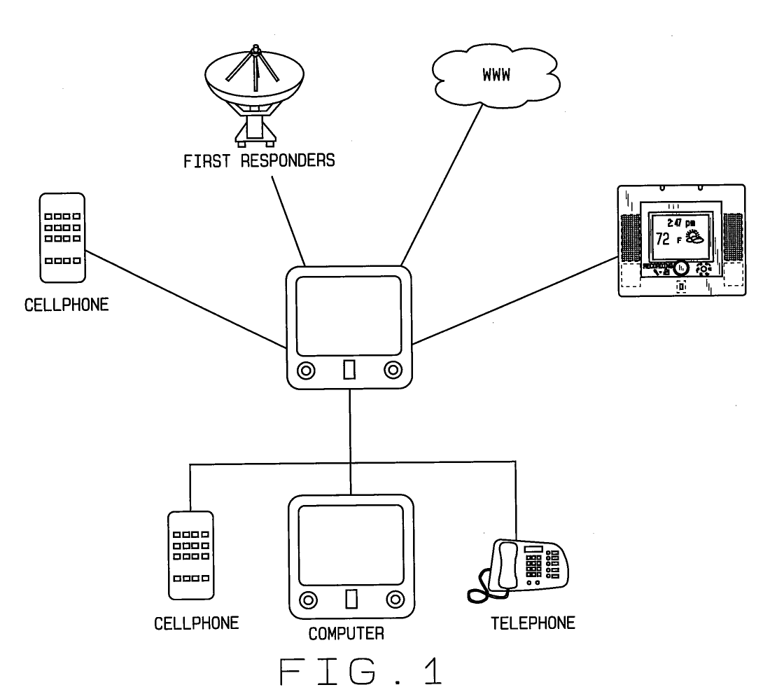

As shown in FIG. 1, an embodiment of the present invention, generally referred to as a emergency notification system 100, includes at least one client device 102 operatively connected to at least one server 104 through a communication network 106 to communicate data between the user client device 102 and the server 104 regarding threats. The server 104 administers a monitoring program 108 that permits an administrator to access the server 104 through an administrator client device 109 to monitor the user client device 102 and communicate with users of the user client device 102 regarding threats.

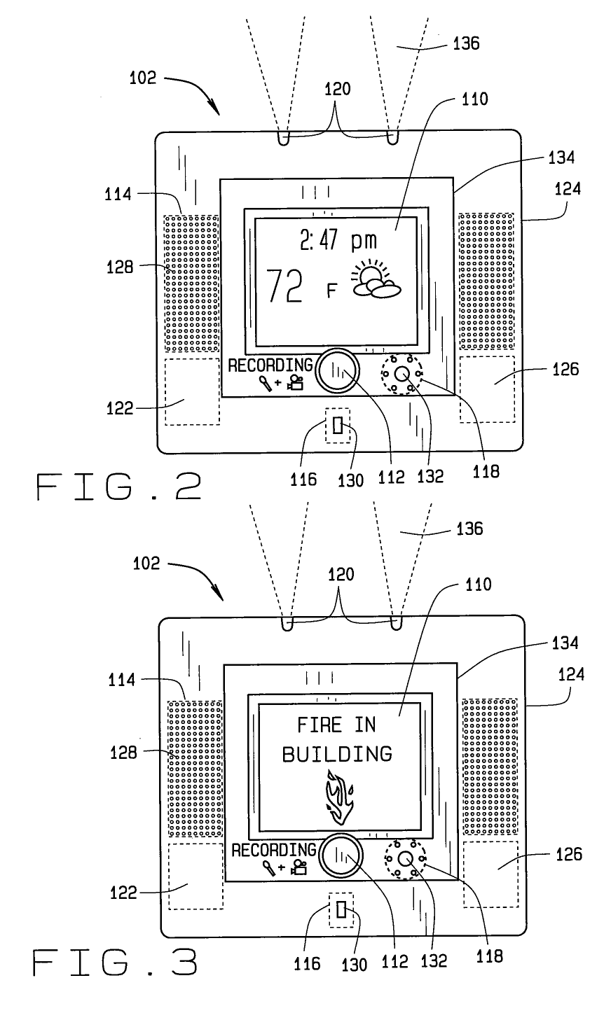

The user client device 102 includes a display device 110, an input device 112, an audio output device 114, an audio recording device 116, a video recording device 118, a signaling device 120, and a back-up power source 122, such as a lithium ion battery, all contained within a generally rectangular housing 124 (FIG. 2). The user client device 102 is also appropriately equipped with a network interfacing device 126 for communicating data with the network 106, preferably PCMCIA/PCI express slots for a cellular pc card or 802.11x. However, the interfacing device 126 can also comprise a 10/100 base-T Ethernet cable, dial-up modem, a cable modem, a satellite connection, a DSL (Digital Subscriber Line) connection, a LAN (Local Area Network), or the like.

The housing 124 mounts to an appropriate surface, such as a wall, using fasteners, adhesive, or other suitable mounting device. Preferably, the housing 124 is mounted in a convenient location so that the client device 102 is easily accessible by members of the public; including, but not limited to, locations such as medical facilities, school campuses, corporate campuses, office buildings, entertainment venues, restaurants, transportation terminals, hotels, government buildings, and shopping malls. A plurality of holes 128 along the sides of the housing 124 permit sound to emit from the audio output device 114, such as loudspeakers. A first hole 130 positioned at the bottom edge of the housing 124 permits the audio input device 116, such as a microphone, to receive an audio input. A second hole 132 along the bottom edge of the housing 124 permits the video input device 118, such as a web camera, to receive video input. An opening 134 in generally the center of the housing 124 receives the display device 110. Other embodiments of the user client device 102 can include other arrangements of the plurality of holes 128, the microphone hole 130, the camera hole 132, and the display opening 134, to accommodate aesthetic, ergonomic, and other design requirements.

The display device 110 is preferably a liquid crystal display (LCD), but can comprise any suitable display technology, such as plasma, light emitting diode (LED), cathode ray tube (CRT), liquid crystal on silicone (LCoS), digital light processor (DLP), and the like (FIG. 1). In alternate embodiments, the display device 110 can also utilize touch screen technology. The display 110 can present various types of content from plain textual information to more complex multimedia and interactive content, such as software programs, graphics, videos, and so forth. The content and operation of the display device 110 is managed by the server 104 through the monitoring program 108, which is operatively connected to the network 106.

In the embodiment of FIGS. 2-3, the input device 112 is a call button positioned just below the display device 110. Preferably, the input device 112 is illuminated, such as with backlighting, to enhance its visibility. A user presses the input device 122 to activate the user client device 102 and send a signal indicating a threat from the user client device 102 to the server 104.

The signaling device 120 is preferably a pair of light emitting diodes (LED) positioned along the upper edge of the housing 124 to illuminate the wall with light 136 of a predetermined color to signal either an alert mode or a safe mode. For example, the LED's can illuminate in a red color to indicate a alert mode and illuminate in a green color to indicate a safe mode. Additional lighting effects can be utilized to enhance the effectiveness of the signaling device, such as flashing the LED's, or creating light patterns or images on the wall.

Alternate embodiments of user client device 102 include any electrical or electronic device capable of communicating with the server 104 through the network 106, such as, for example, a cellular phone or personal digital assistant (PDA) 136, a telephone, a computer 138, or a television operating with a cable or satellite television interactive system 140 (FIG. 1).

The server 104 preferably comprises a computer system, having a processor, memory, and a mass storage device, which is capable of running a monitoring program 108. Also, the server 104 is appropriately equipped with a network interfacing device for communicating data with the network 106, preferably PCMCIA/PCI express slots for a cellular pc card or 802.11x. However, the interfacing device can also comprise a 10/100 base-T Ethernet cable, dial-up modem, a cable modem, a satellite connection, a DSL (Digital Subscriber Line) connection, a LAN (Local Area Network), or the like. If necessary to accommodate large amounts of information or run numerous applications, alternate embodiments of the host server 104 can comprise multiple computer systems, multiple databases, or any combination thereof. Preferably, the server 104 is located in a remote location that is secure and protected from environmental distress and unauthorized access. In addition, the server 104 preferably connects to the user server device 102 and the administrator device 109 with a Secure Socket Layer (SSL) tunnel. Alternatively, the server 104 operatively connects to the user server device 102 and the administrator client device 109 wirelessly, such as with Wi-Fi or other wireless network. For system redundancy, the server 104 can operatively connect the user client device 102 and the administrator client device 109 using both SSL and wireless communications.

The server 104 can be accessed by an administrator through the administrator client device 109, which can comprise either a computer 142, a cell phone 144, or a telephone 146. The monitoring program 108 restricts access to the server 104 with password protection technology. An additional level of security may be utilized through a rolling access code system, delivered via a key fob receiver. To further protect the integrity of the system, the monitoring program 108 preferably uses encryption technology for all communications between the server 104, the administrator client device 109, and the user client device 104. Thus, the emergency notification system 100 is a secure system that allows only specified administrators to disseminate proactive life-saving and protective alert information and instructions through user client devices 104 to a discrete subset of users regarding a threat.

In safe mode, the client device 102 displays information, such as time and weather updates, as well as campus/building information, retail promotional messaging, and advertising (FIG. 2). Once authorized by password verification by the monitoring program 108, an administrator monitors the user client device 102 through the administrator client device 109. When a threat arises, a user engages the client device 102 by pressing the input device 112. The client device 102 sends a signal through the network 106 to the server 104 indicating that the input device 112 has been engaged. The monitoring program 108 sends a signal to the client device 102 to switch to alert mode.

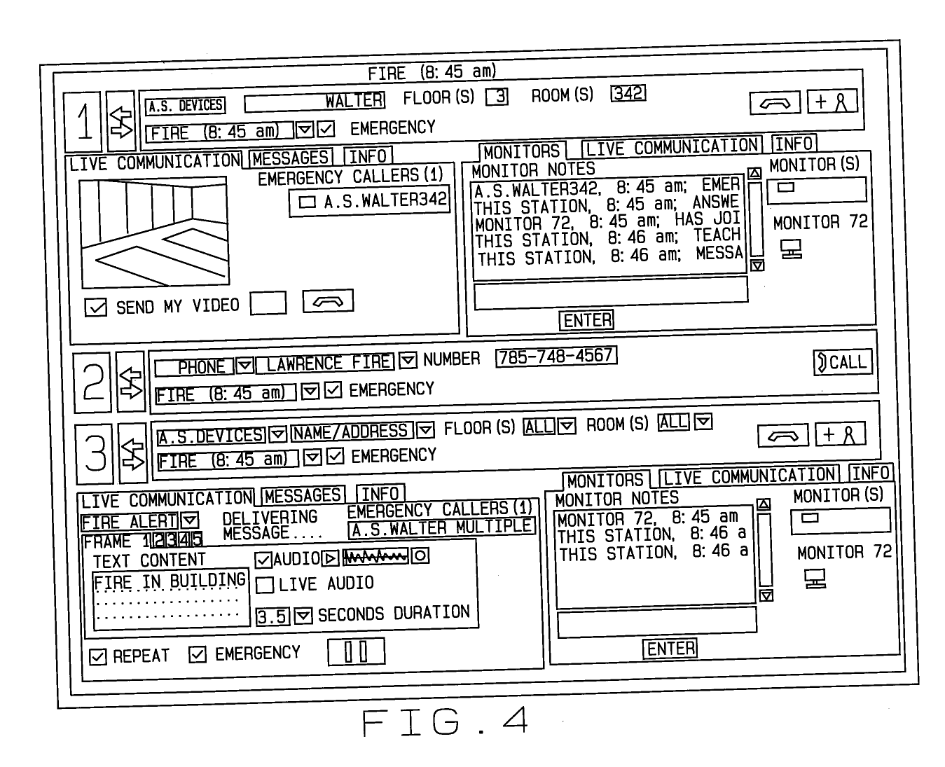

In alert mode, the signaling device 120 activates, thereby, illuminating the LED's with a red color and an audio signal plays through the audio output device 114 (FIG. 2). In addition, the display panel 110 indicates the transmission of the signal to the server 104 with a text message. Moreover, the client device 102 begins transmitting audio and video data from the audio input device 116 and the video input device 118 to the server 104. During the alert mode, the server 104 records the audio and video data transmitted between the client server device 102 and the administrator client device 109, to create a record of the event. The monitoring program 108 receives the signal and audio and video data and transmits the data to the administrator client device 109 for display as a software page 150 (FIG. 4). In addition, the monitoring program 108 allows the administrator to transmit audio and video data from the administrator client device 109 through the server 104 and network 106 to the user client device 102, thereby establishing two-way communication between the administrator and the user. The administrator client device 109 displays a set of prompts to follow so that the administrator can analyze the audio and video data and determine the presence and nature of the threat. In addition, the administrator can annotate the record, such as inputting text through a keyboard.

Once the administrator has determined the presence and nature of the threat, the administrator inputs the threat into the software page 150, such as by selecting the type of threat from a drop-down menu. Based on the threat selected, the monitoring program 108 initiates a predetermined action. For example, the monitoring program 108 can transmit alert information, such as instructions, to the user client device 102 to be followed by people within the area of the user client device 102. Instructions can include, but are not limited to, instructions to move to a specific area, such as an exit, basement, fire escape, or shelter. Instructions can also include tasks, such as lock door. The instructions can be transmitted to all client devices 102 or a discrete subset of client devices 102. Alternatively, separate sets of instructions can be transmitted to different discrete subsets of client devices 102. In addition, the monitoring program 108 can notify first responders, such an police, fire, and medical authorities.

In addition, the server 104 can transmit instructions to a remote device such as cellular phone or personal digital assistant (PDA) 136, a telephone, a computer 138, or a television operating with a cable or satellite television interactive system 140. This enables administrators to reach the widest possible remote audience that may be affected by the alert information, but who may not be currently within client device 102 alert coverage area. Additionally, the monitoring program 108 may be utilized independently of a client device 102 installation for users who seek level of secure information dissemination beyond the physical boundaries of a facility.

Subsequently, the administrator can continue to monitor the client device 102 and communicate with the user during the threat. When the threat has passed, the administrator inputs into the software page 150 the completion of the event and the server 104 signals the client device 102 to return to safe mode.

What is claimed is:

1. An emergency notification system, comprising:
a server capable of administering a monitoring program;
a plurality of user client devices operatively connected to the server and positioned in multiple remote locations that are accessible to users for engagement;
an administrator client device operatively connected to the server to monitor and communicate with the plurality of user client devices;
wherein the administrator client device is capable of communicating alert information to a discrete subset of the plurality of user client devices.

2. The emergency notification system of claim 1, further comprising:
encryption software installed on the server to encrypt communications between the user client devices, the administrator client device, and the server.

3. The emergency notification system of claim 1, further comprising:
password verification software installed on the server to restrict access to authorized administrators.

4. The emergency notification system of claim 1, wherein the user client device comprises:
a housing;
a display mounted within the housing positioned to display alert information;
an audio input device mounted within the housing;
a video input device mounted within the housing;
an audio output device mounted within the housing;
a signaling device to indicate a threat; and
an input device for engagement by a user.

5. An emergency notification system, comprising:
a plurality of user client devices positioned in remote locations that are accessible to users, wherein the users engage the user client devices to indicate the presence of a threat;
an administrator client device operatively connected to the plurality of client devices to monitor and communicate with the plurality of user client devices;
a monitoring program installed on the administrator client device to communicate alert information to a discrete subset of the plurality of user client devices when a threat is indicated.

6. The emergency notification system of claim 5, further comprising:
encryption software installed on the server to encrypt communications between the user client devices, the administrator client device, and the server.

7. The emergency notification system of claim 5, further comprising:
password verification software installed on the server to restrict access to authorized administrators.

8. The emergency notification system of claim 5, wherein the user client device comprises:
a housing;
a display mounted within the housing positioned to display alert information;
an audio input device mounted within the housing;
a video input device mounted within the housing;
an audio output device mounted within the housing;
a signaling device to indicate a threat; and
an input device for engagement by a user.

9. A method of administering an emergency notification system through a computer system having a server, a plurality of user client devices, an administrator client device, and a communication network operatively and electrically connecting the user client device, the administrator client device and the server, the method comprising the steps of:
monitoring the user client devices with the administrator client device;
engaging an input device of the user client devices;
communicating a signal from the user client devices to the server to indicate a threat;
switching the user client devices from safe mode to alert mode;
communicating audio and video data from the user client devices to the administrator client device;
communicating audio and video data from the administrator client devices to the user client device;
determining the presence and nature of the threat;
inputting the presence and nature of the threat into the administrator client device; and
transmitting alert information from the server to the user client devices.

10. The method of claim 9, further comprising:
communicating alert information from the server to a discrete subset of user client devices.

11. The method of claim 9 further comprising:
recording the audio and video data communicating between the user client devices and the administrator device to create a record.

12. The method of claim 11, further comprising:
annotating the record with administrator comments.

13. The method of claim 9, further comprising:
communicating alert information from the server to remote user client devices.

14. The method of claim 9, further comprising:
encrypting the communications between the administrator client device, the server, and the user client device.

15. The method of claim 9, wherein the user client device comprises:
a housing;
a display mounted within the housing positioned to display alert information;
an audio input device mounted within the housing;
a video input device mounted within the housing;
an audio output device mounted within the housing;
a signaling device to indicate a threat; and
an input button for engagement by a user.
